(19) United States
(12) Patent Application Publication
(10) Pub. No.: US 2005/0018199 A1
(43) Pub. Date: Jan. 27, 2005

(54) Fiber array interferometer for inspecting glass sheets

(76) Inventor: Philip R. LeBlanc, Corning, NY (US)

Correspondence Address: CORNING INCORPORATED, SP-TI-3-1, CORNING, NY, 14831, US

(21) Appl. No.: 10/626,309

(22) Filed: Jul. 24, 2003

(51) Int. Cl. G01B 9/02

(52) U.S. Cl. 356/477

(57) ABSTRACT

A major surface (11) of a large substrate (31), e.g., a sheet of transparent LCD glass, is inspected for defects with high resolution and height sensitivity using an array (13) of optical fibers (15). For each fiber (15), a reference beam of coherent light, which has reflected from the fiber's cleaved end (19), interferes with a measurement beam of coherent light, which has exited the cleaved end (19), reflected from the surface (11), and reentered the fiber (15). The intensity of the interference signal serves as a measure of the distance between the cleaved end (19) and the region (27) of the surface (11) with which the fiber (15) is associated. Insight into the polarization properties of the defect, as an aid to accurate classification, can be obtained by independently monitoring the polarization states of two orthogonal measurement beams.

### FIELD OF THE INVENTION

This invention relates to the inspection of glass sheets and, in particular, to the inspection of glass sheets of the type used as substrates in liquid crystal displays (LCDs).

### BACKGROUND OF THE INVENTION

As is well known, liquid crystal displays (LCDs) are composed of a layer of a liquid crystal material sandwiched between two thin glass sheets. Typically, one of the glass sheets serves as a substrate upon which electrical components, e.g., thin film transistors (TFTs), are formed to define the individual pixels of the display. LCDs of this type are known as active matrix liquid crystal displays or AMLCDs.

Thin film transistors formed on glass substrates have narrow performance tolerances. Substrate defects, such as, glass chips, scratches, blisters, inclusions, and stains, can readily lead to product rejects. In particular, the thin contact leads for the TFTs are especially sensitive to sharp variations in height, which can cause open circuits. FIGS. 1A and 1B show examples of a typical surface defect on a glass substrate (FIG. 1A) and an open circuit in a contact lead of an AMLCD which results in an inoperative pixel (FIG. 1B).

To address these problems, glass sheets which are to be used as substrates for LCDs are subjected to on-line inspection as part of the manufacturing process. For example, at Corning Incorporated, the assignee of this application, inspection of glass substrates currently involves a combination of human visual inspection and an operator-assisted automatic inspection system, which uses brightfield and darkfield microscopy techniques.

Human inspection is very fast but has poor resolution, at no better than 50 microns, and poor repeatability. Higher resolution can be achieved with a brightfield/darkfield automatic inspection system. However, increases in resolution for such systems has meant slower inspection speeds. For the glass sheets currently being manufactured for use as LCD substrates, speed considerations have limited automatic inspection to the 20 micron level.

Current trends in the LCD substrate field are in the direction of larger substrates with tighter tolerances on defects. These trends place ever higher demands on an inspection system. For example, it is expected that glass sheets having sizes on the order of 2,000 mm×2,000 mm will need to be inspected on at least one of their sides, i.e., the side on which the TFTs will be formed, for defects on the order of 0.5 microns in size and 0.25 microns in height.

Significantly, neither visual nor current brightfield/darkfield automatic inspection can measure heights of defects. Moreover, conventional approaches for determining the height of surface features, such as, Phase Shifting Interferometry (PSI) and Atomic Force Microscopy (AFM), are ill-suited for large area scans. This becomes especially evident when it is considered that on-line sheet inspection typically needs to be performed in 30 seconds or less.

The particular nature of a defect, e.g., whether it is a bubble, scratch, stain, chip, or the like, is in general not of concern to the purchasers of glass substrates, i.e., the purchaser wants a substrate that is free of objectionable defects, irrespective of the type of defect. However, from a glass manufacturing point of view, it is desirable to have information regarding the type of defect which is appearing in the finished glass sheets so that appropriate corrective measures can be taken to eliminate the defect.

Thus, although defect identification and height measurements are of primary concern, an on-line inspection system which also provides information regarding defect type would also be desirable.

### SUMMARY OF THE INVENTION

In accordance with one of its aspects, the invention provides a method for inspecting a surface (11) of a sheet of material (e.g., a glass sheet 31 having an optical reflectivity of less than 10% and typically less than 5%) comprising:
(a) providing a plurality of optical fibers (15), each fiber having a cleaved end (19), said cleaved ends being arranged in an array (13) which has a longitudinal axis (e.g., the x-axis in FIG. 2);
(b) positioning said array (13) with respect to said surface (11) so that each optical fiber (15) is associated with a region (27) of the surface (11);
(c) for each optical fiber (15), introducing coherent light (49) into the fiber to produce reference and measurement beams which optically interfere with each other, said reference beam comprising light that has been reflected by the cleaved end (19) without passing out of the fiber (15) and said measurement beam comprising light that has passed out of the fiber (15) through the cleaved end (19), has reflected from the region (27) of the surface (11) associated with the fiber (15), and has reentered the fiber (15) through the cleaved end (19); and
(d) for each optical fiber (15), detecting the intensity of the interfering reference and measurement beams (e.g., detecting the intensity with a single detector (33) or a pair of detectors (65, 67)), said intensity being a measure of the distance between the cleaved end (19) and the region (27) of the surface (11) associated with the fiber (15).

In accordance with certain preferred embodiments of this aspect of the invention, step (b) comprises using the detected intensity for the interfering reference and measurement beams for at least one of the fibers (15) as a feedback variable for positioning the array (13) adjacent to the surface (11).

In accordance with another of its aspects, the invention provides a method for inspecting a surface (11) of a sheet of material (31) comprising:
(a) providing a plurality of polarization-maintaining optical fibers (e.g., fibers 15 in FIG. 7), each fiber (15) having a cleaved end (19), said cleaved ends being arranged in an array (13) which has a longitudinal axis (e.g., the x-axis in FIG. 2);
(b) positioning said array (13) with respect to said surface (11) so that each optical fiber (15) is associated with a region (27) of the surface (11);
(c) for each optical fiber (15), introducing unpolarized coherent light into the fiber to produce reference and measurement beams which optically interfere with each other, said reference beam comprising light that has been reflected by the cleaved end (19) without passing out of the fiber (15) and said measurement beam comprising light that has passed out of the fiber (15) through the cleaved end (19), has reflected from the region (27) of the surface (11) associated with the fiber (15), and has reentered the fiber (15) through the cleaved end (19); and
(d) for at least one of the optical fibers (15):
(i) splitting the interfering reference and measurement beams into two orthogonal components based on polarization (e.g., splitting the interfering beams with a polarization beam splitter (59));
(ii) individually detecting the intensities of said components (e.g., detecting the intensities of the components using a pair of independent photodetectors (65,67); and
(iii) comparing said individually detected intensities to determine a property of the region (27) of the surface (11) associated with the fiber (15) (e.g., comparing the individually detected intensities to provide information regarding such polarization-affecting properties as the presence of a defect with a high aspect ratio and/or the presence of a defect which comprises a change in the chemical composition of the surface).

In accordance with a still further aspect, the invention provides a method for inspecting a region (27) of a surface (11) of a sheet of material (31) comprising:
(a) providing a polarization-maintaining optical fiber (e.g., fiber 15 in FIG. 7) having a cleaved end (19);
(b) positioning the cleaved end (19) adjacent to the region (27) of the surface (11);
(c) introducing unpolarized coherent light into the fiber to produce reference and measurement beams which optically interfere with each other, said reference beam comprising light that has been reflected by the cleaved end (19) without passing out of the fiber (15) and said measurement beam comprising light that has passed out of the fiber (15) through the cleaved end (19), has reflected from the region (27) of the surface (11), and has reentered the fiber (15) through the cleaved end (19);
(d) splitting the interfering reference and measurement beams into two orthogonal components based on polarization (e.g., splitting the interfering beams with a polarization beam splitter (59)); and
(e) individually detecting the intensities of said components (e.g., detecting the intensities of the components using a pair of independent photodetectors (65,67);
wherein the relative magnitudes of said individually detected intensities is indicative of a characteristic of the region (27) of the surface (11) which reflected the measurement beam (e.g., the relative magnitudes provide information regarding such polarization-affecting characteristics as the presence of a defect with a high aspect ratio and/or the presence of a defect which comprises a change in the chemical composition of the surface).

Preferably, the entire usable surface of a sheet of material is inspected by repeated application at different positions on the surface of one or more of the foregoing aspects of the invention so that the entire surface is scanned, e.g., by moving fiber array 13 along one or both of the x and y axes in FIG. 2.

The invention also provides apparatus for practicing each of the above inspection methods.

The reference numbers used in the above summaries of the various aspects of the invention are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification.

### BRIEF DESCRIPTION OF THE DRAWINGS

FIG. 1A is a photomicrograph showing a surface defect, specifically, a glass chip, on a glass substrate, specifically, a piece of LCD glass. The bar in the legend to this figure is 10 microns long and the chip thus has a major dimension of approximately 20 microns.

FIG. 1B is a photomicrograph showing an open circuit in the TFT pixel control electronics of an AMLCD. Such an open circuit can be caused by a defect of the type shown in FIG. 1.

FIG. 2 is a schematic perspective view showing a fiber array interferometer inspecting the surface of a substrate in accordance with the invention.

FIG. 3 is a schematic perspective view showing a first embodiment of a fiber array for use in the fiber array interferometer of FIG. 2.

FIG. 4 is a schematic cross-sectional view showing a second embodiment of a fiber array for use in the fiber array interferometer of FIG. 2.

FIG. 5 is a schematic diagram illustrating light paths for one channel of a fiber array.

FIG. 6 is a schematic diagram illustrating the interference fringes produced by the fiber interferometer of FIG. 5 for optical path length (OPL) differences of λ/4.

FIG. 7 is a schematic diagram illustrating light paths for one channel of a fiber array which is capable of providing information regarding the polarization-affecting properties of a surface defect.

FIG. 8 is a schematic diagram illustrating the incorporation of the single fiber systems of FIG. 5 and/or 7 in an array format.

FIG. 9 shows raw data obtained with a single fiber system of the type shown in FIG. 5.

FIGS. 10-12 show three levels of processing of the data of FIG. 9 to remove the effects of interferometric fringes (FIG. 10) and tilt (FIG. 11). FIG. 12 shows the final surface map thus obtained.

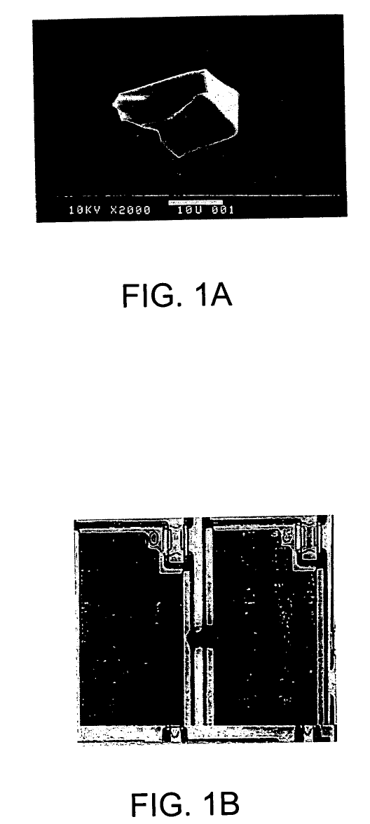

In the above drawings, like reference numbers designate like or corresponding parts throughout the several views. The elements to which the reference numbers generally correspond are set forth in Table 1.

### DESCRIPTION OF THE PREFERRED EMBODIMENTS

In its preferred embodiments, the present invention relates to the inspection of glass sheets and, in particular, to the inspection of LCD glass sheets to determine if defects are present which make the sheet unsuitable for use in the manufacture of liquid crystal displays.

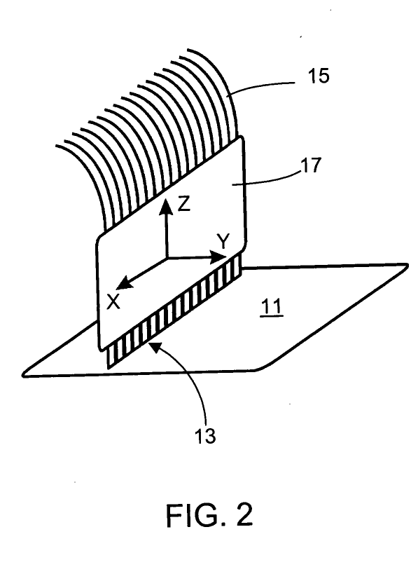

In overview, the invention employs a parallel array of all-fiber interferometers (arranged in a Fizeau or Fabry-Perot configuration) which is scanned along an axis normal to the plane of the array (e.g., the array is scanned along the y-axis in FIG. 2; see below). For light having a wavelength λ, height resolution can be better than λ/1000 and spatial resolution can be around λ, which is comparable to the spatial resolution achieved with conventional optical microscopy. These height and spatial resolutions make the invention particularly well suited for finding localized, small variations in the height of the surface of the glass, i.e., they make the invention particularly well suited to finding defects. Compared to standard inspection techniques, such as Phase Shifting Interferometry and Atomic Force Microscopy, the invention provides increased scanning area and increased scanning speed.

Individual fibers of the fiber arrays used in the invention cover an area of the substrate limited primarily by the core-to-core separation distance between the fibers. The effects of diffraction at the cleaved ends of the fibers are lessened by using short wavelength sources and reducing the spacing between the fibers and the surface. If desired, the array may be dithered normal to the scan direction in order to increase the coverage of the array. As discussed more fully below, full coverage can also be achieved by using multiple layers of fibers. For a suitable number of staggered rows of fibers (depending on the core size), full coverage throughout the width of the array can be achieved without the need for lateral dithering.

The scan size of the fiber array interferometer is limited only by the number of fibers in the array and the range of motion of the controller used to move the array over the surface being inspected. The scan speed is proportional to the product of the fiber array size and the detection bandwidth of the interferometers, both of which can be very large (e.g., a typical detector such as a PIN photodiode has a response time of around 25 nanoseconds).

FIG. 2 is a schematic diagram illustrating a typical embodiment of the invention. In this FIG. 11 is one of the flat, major surfaces of the substrate which is to be inspected, e.g., a sheet of LCD glass, 13 is an array of optical fibers, e.g., a parallel array of single mode optical waveguide fibers, 15 are individual fibers which receive coherent input light from one or more sources and provide reflected, interfering, output light to one or more detectors (see below), and 17 is a motion control system (e.g., a combination piezoelectric- and stepper motor-based system) for moving array 13 relative to surface 11.

More particularly, motion control system 17 both positions the ends of the fibers sufficiently close to surface 11 to produce a suitable contrast in the interferometric signal (e.g., at a distance of less than about 100 microns) and scans array 13 in one or more passes over the surface to detect defects. Depending on the sizes of the substrate and the array, the scanning can be along just the y-axis in FIG. 2 or can involve scanning in both the x and y directions, e.g., in a serpentine (or raster) pattern. Also, as discussed above, for any particular scan in the y-direction, dithering in the x-direction can be performed to provide full surface coverage during the scan.

Typically, the substrate will be stationary during scanning, but can be moved to, for example, bring different parts of surface 11 into position for inspection. Alternatively, but not preferred, array 13 can be held stationary and the substrate moved during a scan. Although shown horizontal in FIG. 2, for many applications, the substrate will be vertical or nearly vertical during inspection.

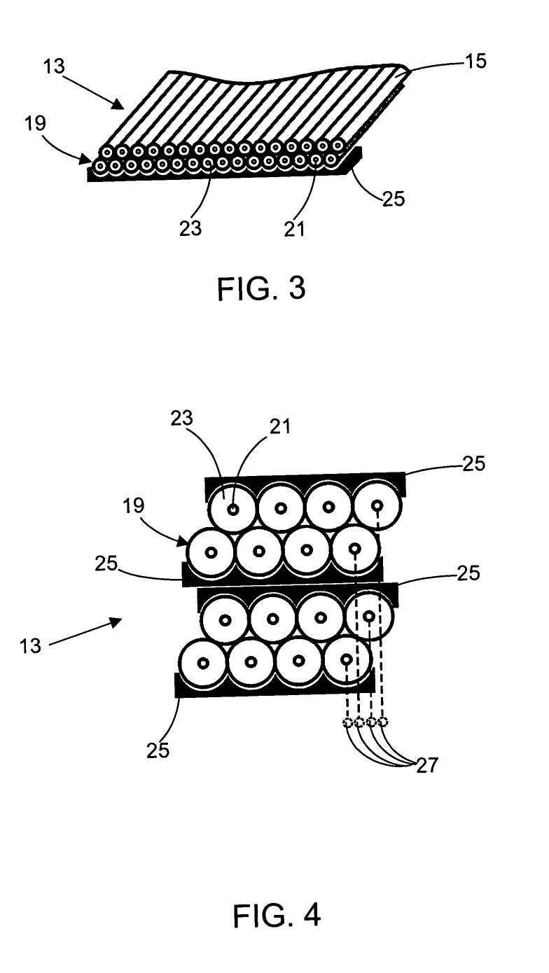

FIGS. 3 and 4 show two embodiments of fiber array 13. For both embodiments, each fiber 15 in the array has a cleaved end 19, a core 21, and a cladding 23. The fibers are supported and aligned using a support structure 25, which, for example, can be a polymeric gripper of the type disclosed in commonly assigned U.S. Pat. No. 6,266,472. The support structure holds the fibers in position just above their cleaved ends.

Preferably, as shown in these figures, the plastic protective coating (plastic jacket) which surrounds the cladding of a typical optical fiber is removed in the region of the cleaved ends so that the claddings of the individual fibers can be brought into contact, i.e., so that a close-packed arrangement can be achieved. In this way, the distance between cores 21 is reduced which increases the spatial resolution of the array, i.e., it reduces the distance on the surface of the substrate between the spots of light produced by the individual fibers. If desired, a further reduction in the spacing of the cores can be achieved by tapering the claddings in the region of the cleaved ends. For example, for a fiber having a core diameter of 8 microns and a cladding diameter of 125 microns, a taper which reduces the cladding diameter to 10 microns over a distance of 1 millimeter from cleaved end 19 can be used in the practice of the invention.

FIG. 3 illustrates the use of two stagger rows of fibers to produce array 13, while FIG. 4 illustrates the use of four staggered rows, e.g., two staggered sets of the two staggered row structure of FIG. 3. Like the removal of the plastic coating from the cladding, the use of stagger rows increases the spatial resolution of the system. For example, as shown in FIG. 4, the light spots 27 produced by the individual fibers of this staggered four row embodiment are essentially in contact. During an inspection, each light spot is associated with a region of surface 11 and thus by having an array which produces closely spaced light spots, substantially all areas of a substrate can be inspected for defects. Note that for typical single-mode fiber, it would be necessary to stagger about 15 rows in the array for full coverage.

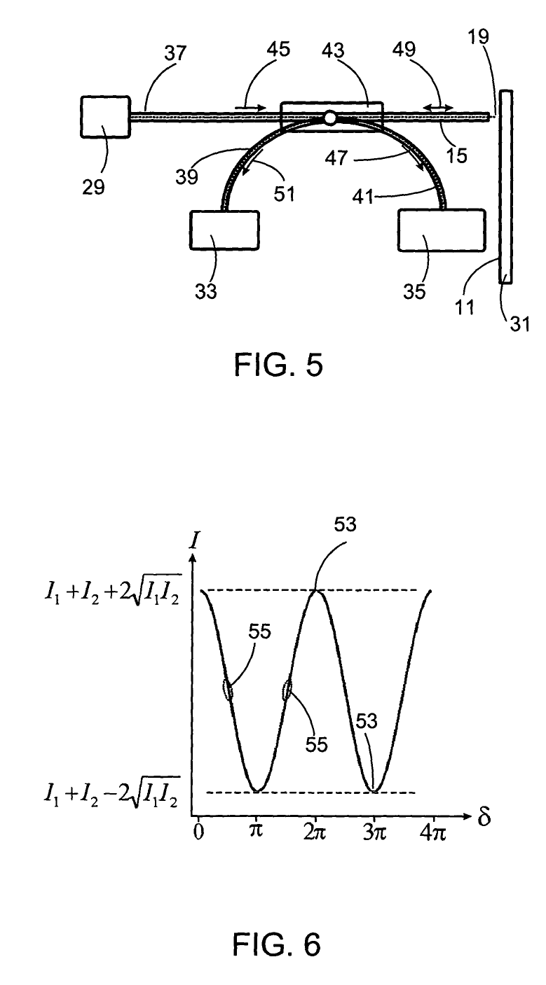

FIG. 5 illustrates the operating principles of the invention. In the embodiment of this figure, the all-fiber interferometer is setup in a Fizeau (or Fabry-Perot) configuration and is composed of a laser diode source 29, a 2×2 50/50 fiber coupler 43, and two photodetectors 33, 35, all of which are coupled to single-mode optical fibers 15, 37, 41, and 39. Fibers 15,37 and fibers 39,41 can each be in the form of a single continuous fiber, but typically will be individual fibers spliced to the pigtails of coupler 43.

The interferometric setup of FIG. 5 has been described in D. Rugar, H. J. Mamin, and P. Guthner, Appl. Phys. Lett., 55, 2588 (1989) for use in an atomic force microscope to sense the position of the cantilever used in such a device. Significantly, in this reference, light is reflected from the cantilever and not the specimen being examined. Also, the authors state that they metalized the cantilever with a thin gold layer to increase optical reflectivity. The setup of this article is also shown in Mamin et al., U.S. Pat. No. 5,017,010.

In the present invention, light is reflected directly from the surface of a substrate without any added reflective coatings. Moreover, glass substrates have low reflectivity. For example, for each fiber in array 13, much less than 10 percent, e.g., less than 5 percent, of the light that passes out of the fiber reflects from the region of the surface associated with the fiber. The rest of the light simply passes through the transparent substrate. Yet, as demonstrated by, for example, the data presented below, the invention has been found to be highly effective in inspecting transparent glass surfaces for changes in height, notwithstanding this low reflectivity.

As shown by arrow 45 in FIG. 5, laser light from laser diode 29 is coupled into single mode fiber 37 and propagates towards 50/50 coupler 43. Fiber 37 thus serves as an input arm of the coupler. As shown by arrow 47, fiber 41, which is connected to photodetector 35, serves as one of the output arms of the coupler. This photodetector serves as a reference to monitor changes in laser output intensity. For a sufficiently stable laser, such monitoring may not be necessary and thus fiber 41 and photodetector 35 can be eliminated, as illustrated, for example, in FIG. 8 discussed below. The laser diode or other light source preferably produces light which is not significantly attenuated during propagation through the optical fibers. For example, various optical fibers have a band of low loss transmission wavelengths in the long wavelength visible range or the infrared range. In general, the light source(s) and the fibers of the fiber ribbon (fiber array) preferably are tailored to one another to minimize attenuation and thus maximize the detector signal.

As shown by arrow 49 (in particular, the right hand arrowhead of this arrow), light from the second output arm of the coupler is transmitted towards surface 11 of substrate 31 by fiber 15. The distal end of this fiber is cleaved, e.g., normal to the fiber axis, and is brought close to the substrate surface, e.g., within 100 microns of the surface and preferably within a few microns of the surface. The cleaved surface collects light which has reflected from the surface and that light plus light which has reflected from the cleaved surface without leaving the fiber, propagate back through fiber 15 towards coupler 43 (see the left hand arrowhead of arrow 49).

As shown by arrow 51, this backwards propagating light exits coupler 43 and is transmitted to high bandwidth (e.g., 40 Mhz) photodetector 33 by fiber 39. Because the light which reaches the photodetector is composed of the coherent superposition of light which has reflected from the cleaved end without leaving fiber 15 (the reference beam) and light which has left the fiber, reflected from surface 11, and reentered the fiber (the measurement beam), the output signal of the photodetector depends on the relative phases of those beams, which, in turn, depends on the distance between the cleaved end of the fiber and the surface.

In particular, for an input beam of intensity I₀ in fiber 15, the beam which reflects from the cleaved end without leaving the fiber (the reference beam) will have an intensity (I₁) of about 0.04•I₀. This intensity is based on the Fresnel reflection coefficient R which, for normal incidence, is given by:

$$R = {( \frac{{n}_{1} - {n}_{2}}{{n}_{1} + {n}_{2}} )}^{2}$$

where n₁ and n₂ are the indices of refraction of the two media, which in this case are glass (n₁≈1.5) and air (n₂≈1.0).

The remaining 0.96•I₀ is incident upon the substrate. For a glass substrate, reflection off the glass and again at the air-fiber interface leads to a beam (the measurement beam) of intensity I₂≈0.037•I₀ propagating back into the fiber coupler. The two beams superimpose, producing an interference pattern at photodetector 33 given by
I=I₁+I₂+2\sqrt{I₁I₂}cos δ (1)
where δ is the optical path length (OPL) difference between the two beams. In this case,

$$δ = \frac{4 π d}{λ} \qquad ( 2 )$$

where d represents the spacing between the cleaved end of the fiber and the glass surface and λ is the wavelength of light produced by the laser diode. Additional reflections, say from the back side of a glass substrate, can be considered for higher order interference effects. In practice, these additional components can be minimized by using a short coherence length laser.

Assuming that the two beam intensities, I₁ and I₂, remain constant, the response of the system is given by

$$\frac{Δ I}{2 \sqrt{{I}_{1} {I}_{2}}} = [ \frac{4 π d}{{λ}^{2}} Δ λ - \frac{4 π}{λ} Δ d ] sin \frac{4 π d}{λ} . \qquad ( 3 )$$

The most sensitive operating point of the interferometer is at quadrature (see reference number 55 in FIG. 6), where the two interfering beams are 90 degrees out of phase. In this case, for small changes in distance, Δd, and wavelength, Δλ, the response is linear and is given by

$$\frac{Δ I}{2 \sqrt{{I}_{1} {I}_{2}}} = \frac{4 π d}{{λ}^{2}} Δ λ - \frac{4 π}{λ} Δ d . \qquad ( 4 )$$

In practice, a stable laser light source is used and so Δλ≈0 and enough phase resolution exists to discern variations in the separation between the fiber and the substrate surface at the angstrom level. It should be noted that compared to free-space optics, the fiber-based scanning interferometer of the present invention is substantially immune to thermal effects and vibrations in the common-path components, both of which can be present when inspection is being performed on newly-formed glass sheets since this may be at an elevated temperature. The compactness and immunity to phase distortions of the common-path interferometer make it ideal for an approach where a large number of independent interferometers is scanned over a surface. For example, no signal artifacts would be generated here by flexing the large bundle of fibers as the array is maneuvered over, for example, a 4 meter² area.

For displacements greater than around λ/40, the non-linear phase relationship should be taken into account. A change in d of λ/4 corresponds to an interference “fringe” where the interference intensity passes through an extremum (see reference number 53 in FIG. 6). For changes in the fiber-surface distance larger than λ/4, fringe and surface tracking methods must be used for unambiguous distance measurements. One measure of fringe contrast, known as the visibility, is given by

$$V = \frac{{I}_{max} - {I}_{min}}{{I}_{max} + {I}_{min}} = \frac{2 \sqrt{{I}_{1} {I}_{2}}}{{I}_{1} + {I}_{2}} \qquad ( 5 )$$

and varies between 0 and 1. Note that fringe visibility is independent of the signal-to-noise of the interferometer.

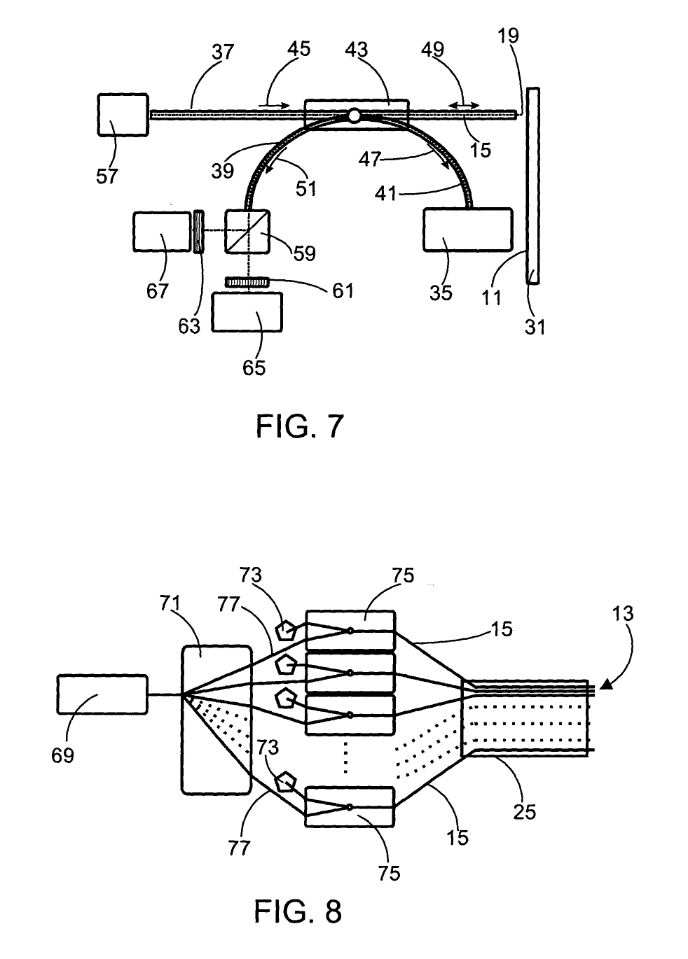

FIG. 7 shows a variation of the embodiment of FIG. 5 which permits defects of flat surfaces to be characterized based on polarization changes in the reflected light. This embodiment uses an unpolarized laser source, polarization-maintaining fiber, and two detectors in order to (a) map the topography of the sample surface and (b) monitor changes in polarization upon reflection.

Such changes in polarization are characteristic of the nature of the surface defect and can allow identification of defect type, which is sometimes left ambiguous in a purely topographical map of a surface. Examples of defects which are capable of producing a polarization change include defects with high aspect ratios, such as, scratches and some bubbles, and defects at which the chemical nature of the surface changes, such as, platinum protrusions and certain stains. Topography alone may not always provide a full characterization of these types of defects.

As opposed to the system of FIG. 5, the implementation of polarization contrast in the scanning fiber interferometer of the invention involves: (a) the use of polarization-maintaining (PM) optical fiber for at least fibers 37, 15, and 39, (b) the use of a polarization-dependent beam splitter 59 or a similar device to separate the light carried by fiber 39 into two orthogonal polarization components, and (c) separate detectors 65 and 67 for the two orthogonal polarization modes. The light source 57 used with this embodiment should be an unpolarized, coherent light source, e.g., a superluminescent diode. Polarizers 61 and 63 can optionally be placed ahead of detectors 65 and 67 to clean-up any leakage between polarization channels exhibited by beam splitter 59.

Other than the foregoing changes, the system of FIG. 7 operates in the same manner as the system of FIG. 5, as indicated by the corresponding reference numbers used in these two figures. As in FIG. 5, for a stable light source, fiber 41 and reference photodetector 35 may not be needed.

For the system of FIG. 7, the topography of the surface can typically be determined based on the intensity detected by either photodetector 65 or photodetector 67, provided their signals vary by the same amount and in the same direction. In this case, a plot of intensity versus position for either photodetector reveals the topography of the surface, giving the size and shape of the surface features in the same manner as does the output of photodetector 33 in FIG. 5. In addition, complementary surface information regarding the nature of a defect can be characterized by a decrease in intensity in only one of the two detectors.

FIG. 8 shows a suitable arrangement for implementing the single fiber systems of FIG. 5 and FIG. 7 in an array format. This embodiment employs a single laser/light source 69 whose output is subdivided by coupler 71 and supplied to a plurality of inputs 77 of 2×1 couplers 75. The outputs of the couplers are attached to fibers 15 which are held in place by support 25 to form fiber array 13. Light returning from the array is detected by photodetectors 73, which may constitute two photodetectors for those embodiments where polarization contrast is determined. To minimize cost and complexity, a linesean detector, such as a CCD or CMOS array, can be used in place of individual detectors 73 for large arrays of fibers.

Using apparatus of the type shown in FIG. 8, various protocols can be implemented to scan large sheets of glass for defects. For example, a rapid scan at relatively low resolution, i.e. a mode where the fiber array is held at a relatively large distance from the surface and scanned rapidly without closed-loop surface tracking, can be performed initially in order to merely locate the presence of a defect. This can be followed by one or more higher resolution scans, where the fibers are brought close to the surface and scanned using full closed-loop surface tracking, limited to those areas of the surface which contained a rapid change in surface profile and thus are likely candidates for the presence of a defect. The higher resolution scan(s) can employ a slower scan rate and/or a smaller spacing between the cleaved ends of the fibers and the substrate's surface and/or smaller incremental steps in the displacement of the array along the x and y axes. These all contribute to obtaining a high spatial resolution as does accurately modeling the Gaussian beam shape at the surface and deconvoluting this from the final image. The higher resolution scan can also include acquisition of polarization contrast information to further characterize the nature of a detected defect. Typically, the lower resolution scan will only include topography information, but can include polarization information if desired. Alternatively, the invention can be practiced using only high resolution scans, which may involve the acquisition of only topography information, only polarization information, or a combination thereof. The invention can, of course, be practiced using protocols other than the foregoing, e.g., a low resolution topography scan followed by a high resolution polarization scan.

The array may be scanned in either open or closed-loop modes. In both modes, the separation between each fiber and the substrate is monitored as a function of position along the scan and then used to generate a 3-dimensional contour map of the surface. In closed-loop scanning, the z-axis offset of the array is compared to a set-point value and maintained constant through sensitive motion control along the z-axis of motion control system 17 of FIG. 2. Proportional feedback control, integral feedback control, or a combination thereof can be used for this purpose. Differential feedback control can also be used, but is generally not needed when glass surfaces are being inspected. The surface profile is then reconstructed from the z-axis position corrections required to maintain the constant fiber-to-sample distance at each scan point. Open-loop scanning generates no such position corrections and so the interference signal will typically move through fringes either slowly, due to a gradual sample tilt, or rapidly, due to a sharp change in the surface topography. These sharp changes can be used as a trigger to signal the presence of a “revisit-able” surface feature. Since there is no feedback required, the open-loop operation is not limited by the dynamic response of the piezoelectric stage and so can operate much more quickly than under closed-loop operation. It is possible to reconstruct the surface topography from the open-loop interference trace through fringe tracking algorithms (see below), though the highest fidelity is achieved through closed-loop operation.

Closed-loop feedback is usually desirable in order to prevent accidental contact between the array and the surface due to a large variation in the height of the substrate, e.g., the presence of a large defect such as a glass chip or simply the sample tilt over large distances. Also, the sensitivity (that is, the visibility) of the interferometer varies with distance from the surface being inspected. Accordingly, for a sample with a tilt, the sensitivity can be greater at the beginning of a scan and decrease as the scan progresses, or vice versa. Closed-loop feedback avoids this problem by holding the distance between the cleaved ends of the fibers and the surface precisely constant throughout the scan. When closed-loop feedback is used, it can be based on a single fiber in the array or multiple fibers, as desired.

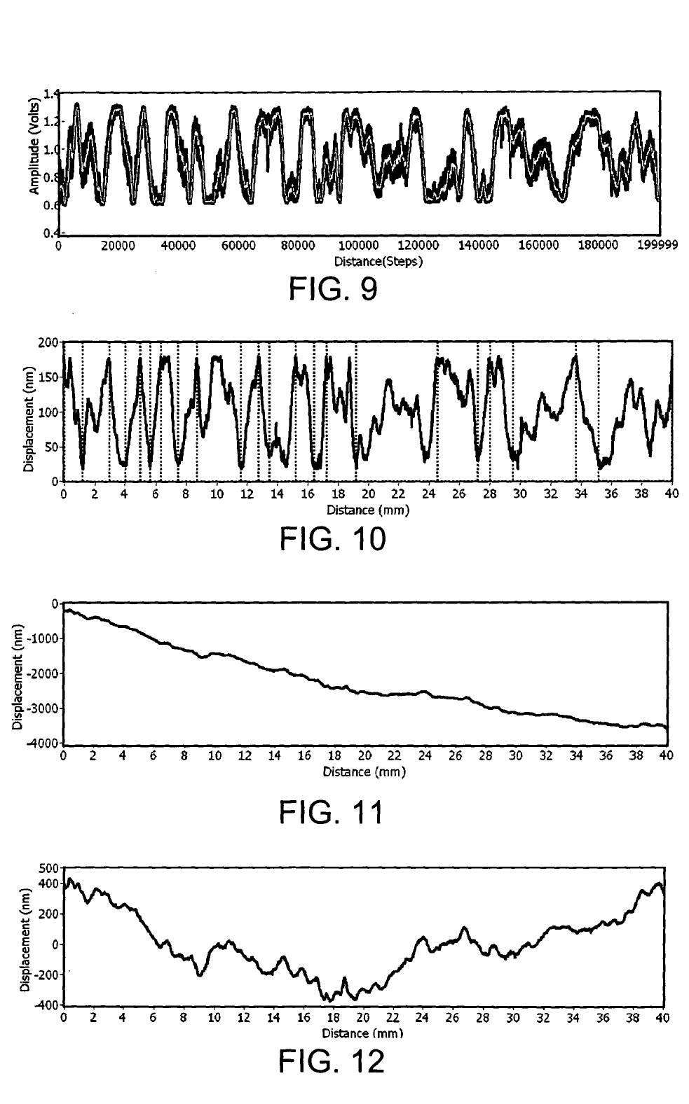

Without intending to limit it in any manner, the present invention will be more fully described by the experimental data of FIGS. 9-12.

The data of these figures was acquired using a single fiber system of the type shown in FIG. 5 with relative movement between the cleaved end of the fiber and the sample being achieved by the combination of a two dimensional piezoelectric translator and a motorized stage on which the sample was mounted. Overall, the system had a resolution of better than 5 nm over a 200 micron dynamic range, determined in this case by bit noise on a 16-bit digital-to-analog converter card. For smaller dynamic ranges, the thermally-limited performance of the interferometer can be recovered.

The experiments were performed using open-loop scanning. Positioning of the fiber and analysis of the output of the photodetector were performed using the commercially available LABVIEW software package from National Instruments. The tests were performed using 0.7 mm thick samples of Code 1737G LCD glass sold by Corning Incorporated. The fiber used was CORNING PUREMODE HI 780 (Corning Incorporated, Corning, N.Y.), and the laser diode operated at a wavelength of 787 nanometers. The data of FIGS. 9-12 is representative data for one sample.

FIG. 9 shows raw data obtained from a scan of the surface of the sample in terms of detector signal (volts) and stepper motor encoder ticks (steps). The central white line in this plot shows the results of low-pass filtering performed on the raw data to reduce high frequency noise.

As discussed above, a significant change in the distance between the cleaved end of a fiber and the surface being inspected alters the sensitivity of the interferometer. To adjust for this effect, the detector signal trace envelope was fit to a cubic spline to determine the top and bottom edges of the fringe pattern. The fit generated a variable scaling factor which was used to stretch the low-visibility data so that all the fringes would have the same peak-to-valley values.

In addition to the scaling, the surface map is preferably expressed in terms of real-world units. Thus, stepper motor encoder steps are preferably converted to millimeters using the encoder quadrature spacing as a calibration reference and detector volts are preferably converted to nanometers. This is done by taking the arccosine of the voltage signal and multiplying by a factor of λ/4π. The wavelength of the laser then serves as the built-in calibration of the interferometer. FIG. 10 shows the results of applying these procedures to the data of FIG. 9.

The peaks and valleys of the resulting trace were then identified using a standard approach of differentiating the trace and finding the locations where the slope passes through zero. This approach finds both interferometric fringes and various smaller peaks (those between the min and max values) which represent actual surface details. Ultimately, the smaller peaks are of interest, but to find them, the interferometric fringes need to be removed (unfolded) from the data.

To eliminate the smaller peaks from consideration during the unfolding process, a series of logic conditions were applied to the series of peaks to identify peaks that were interferometric fringes. First, to be the result of an interferometric fringe, the peak must occur within a certain percentage of the min or max envelope (this is an adjustable parameter which was set to ˜80% in most cases). Second, in practice it has been found that peaks due to interferometric fringes can only occur with a certain frequency. Accordingly, if multiples of the same type of fringe (say, many peak fringes) occur in a small distance, these represent actual features and only the first fringe is unfolded. The dotted vertical lines in FIG. 10 represent the peaks corresponding to interferometric fringes found in this way.

To remove (unfold) the interferometric fringes from the data an assumption is made that the surface is sufficiently smooth so that all occurrences where the interferometer signal passes through a fringe indicate no actual change in the sign of the surface slope. That is, true features on the surface generate details on the interferometric trace which occur between the minimum and maximum of the signal values. The parts of the trace where the signal goes through a fringe (an extremum) actually indicate a continuation of the surface along the previous incline.

Each datum in the array is then added to or subtracted from the previous data such that the real features are preserved and the peaks due to interferometric fringes are removed. In particular, for small defects, e.g., defects of the type which exist on LCD glass, the topography is usually dominated by an overall sample tilt, i.e., an overall upwardly or downwardly sloping line for a one-dimensional scan or a sloping plane for a two-dimensional scan.

For a passive scan, the tilt causes the interferometer signal to undergo several fringes during a typical scan (see, for example, FIGS. 9 and 10). These fringes are a consequence of the cyclical cosine term in the interferometer signal. Once the detector signal is scaled appropriately as discussed above, the fringes must be “unfolded” in order to recover the true surface topography.

Although this can be accomplished in various ways, one approach which has been found to work successfully in practice comprises first locating the peaks and valleys on each trace which correspond to extrema in the cosine term due to the overall slope. Then, each line trace is reconstructed point-by-point in order to remove the fringes.

The first step in the reconstruction is to functionally establish an initial slope to the trace using the first two data points. The height values for the trace are then preserved unchanged for the initial part of the line until the first peak (or valley) is encountered. From this point on, the data points are added or subtracted to the previous data set based on the slope of the particular fringe in which they occur. Table 2 sets forth a conceptual algorithm for this procedure assuming an original 1-dimensional array of height values indexed along position x (i.e., original_trace(x)) and a new “unfolded” array of height values, again indexed along position x (i.e., new_trace(x)). The results of using the procedure of Table 2 are shown in FIG. 11.

As can be seen in this figure, the surface map exhibits an overall slope or tilt, with superimposed waviness. As indicated above, this overall slope or tilt is typical since topography data is usually dominated by an overall plane tilt, which can be due to stage, sample, and/or detector offsets.

To remove the tilt from the open-loop data of this experiment, a best fit line was subtracted from the plot of FIG. 11. The result is shown in FIG. 12 (note the different vertical scales in FIGS. 11 and 12). The ability of the invention to detect small changes in the surface of a transparent sheet of glass is evident in this figure.

From the foregoing, it can be seen that the invention provides methods and apparatus for inspecting large flat substrates for surface defects in a short amount of time. Through the use of a scanning imaging head which comprises a parallel array of all-fiber Fizeau (or Fabry-Perot type) interferometers, a large area topographic map of a surface can be generated with excellent height resolution, e.g., resolution down to the angstrom level. Because of the low cost and low complexity of creating a large size array and the high bandwidth of the detectors used to monitor the output of the interferometers, the time needed to prepare such a map is a small fraction of that of current surface imaging techniques.

Although specific embodiments of the invention have been described and illustrated, it is to be understood that modifications can be made without departing from the invention's spirit and scope. For example, although the preferred application of the invention is in the inspection of glass substrates, e.g., LCD substrates, flat substrates used in such areas as semiconductors and magnetic recording media can also be inspected using the methods and apparatus of the invention.

A variety of other modifications which do not depart from the scope and spirit of the invention will be evident to persons of ordinary skill in the art from the disclosure herein. The following claims are intended to cover the specific embodiments set forth herein as well as such modifications, variations, and equivalents.

TABLE 1

| Number | Element |
|---|---|
| 11 | substrate surface which is to be inspected |
| 13 | fiber array |
| 15 | fiber |
| 17 | motion control system |
| 19 | cleaved end of fiber |
| 21 | fiber core |
| 23 | fiber cladding |
| 25 | support structure for fiber array |
| 27 | light spot produced by an individual |
| | fiber/region of substrate surface associated |
| | with an individual fiber |
| 29 | laser diode |
| 31 | substrate |
| 33 | signal photodetector |
| 35 | reference photodetector |
| 37 | fiber |
| 39 | fiber |
| 41 | fiber |
| 43 | coupler |
| 45 | arrow showing direction of light propagation |
| 47 | arrow showing direction of light propagation |
| 49 | bi-headed arrow showing direction of light |
| | propagation |
| 51 | arrow showing direction of light propagation |
| 53 | fringe |
| 55 | quadrature |
| 57 | unpolarized coherent light source |
| 59 | polarization beam splitter |
| 61 | polarizer |
| 63 | polarizer |
| 65 | signal photodetector |
| 67 | signal photodetector |
| 69 | laser source |
| 71 | coupler |
| 73 | photodetector |
| 75 | 2 × 1 coupler |
| 77 | input to coupler |

TABLE 2

| | |
|---|---|
| Step 1: | Determine the positions of all n extrema, peak(n). |
| | Take peak (n + 1) to correspond to the final point in the trace. |
| Step 2: | new_trace(1) = original_trace(1); |
| | new_trace(2) = original_trace(2) |
| Step 3: | For all other points peak(m) < x ≦ peak(m + 1) on the trace: |
| | new_trace(x) = new_trace(x − 1) |
| | + (−1)\hat{ }(m + 1) |
| | (original_trace(x − 1) − original_trace(x)), |
| | where m = 0, 1, ..., n |

1. A method for inspecting a surface of a sheet of material comprising:
(a) providing a plurality of optical fibers, each fiber having a cleaved end, said cleaved ends being arranged in an array which has a longitudinal axis;
(b) positioning said array with respect to said surface so that each optical fiber is associated with a region of the surface;
(c) for each optical fiber, introducing coherent light into the fiber to produce reference and measurement beams which optically interfere with each other, said reference beam comprising light that has been reflected by the cleaved end without passing out of the fiber and said measurement beam comprising light that has passed out of the fiber through the cleaved end, has reflected from the region of the surface associated with the fiber, and has reentered the fiber through the cleaved end; and
(d) for each optical fiber, detecting the intensity of the interfering reference and measurement beams, said intensity being a measure of the distance between the cleaved end and the region of the surface associated with the fiber.

2. The method of claim 1 wherein for each optical fiber, less than 10 percent of the light that passes out of the fiber through the cleaved end in step (c) reflects from the region of the surface associated with the fiber.

3. The method of claim 1 wherein for each optical fiber, less than 5 percent of the light that passes out of the fiber through the cleaved end in step (c) reflects from the region of the surface associated with the fiber.

4. The method of claim 1 wherein the cleaved ends are arranged in a single row.

5. The method of claim 1 wherein the cleaved ends are arranged in at least two rows with the fibers in one of the rows being staggered relative to the fibers in another of the rows.

6. The method of claim 1 wherein:
(i) each of the optical fibers comprises a core and a cladding; and
(ii) the claddings of at least some of the optical fibers are in contact at the cleaved ends and/or adjacent thereto.

7. The method of claim 6 wherein the claddings of at least some of the fibers are tapered.

8. The method of claim 1 wherein:
(i) in step (a), the optical fibers are polarization-maintaining fibers;
(ii) in step (c), the coherent light is unpolarized light; and
(iii) step (d) comprises the steps of:
(1) splitting the interfering reference and measurement beams into two orthogonal components based on polarization; and
(2) individually detecting the intensity of one of the components.

9. The method of claim 1 including the additional steps of repositioning the array and repeating steps (c) and (d).

10. The method of claim 9 wherein the repositioning comprises moving the array in a direction perpendicular to the longitudinal axis.

11. The method of claim 9 wherein the repositioning comprises moving the array in a direction parallel to the longitudinal axis.

12. The method of claim 1 wherein step (b) comprises using the detected intensity for the interfering reference and measurement beams for at least one of the fibers as a feedback variable for positioning the array adjacent to the surface.

13. The method of claim 1 wherein the sheet of material is a sheet of glass.

14. A method for inspecting a surface of a sheet of material comprising:
(a) providing a plurality of polarization-maintaining optical fibers, each fiber having a cleaved end, said cleaved ends being arranged in an array which has a longitudinal axis;
(b) positioning said array with respect to said surface so that each optical fiber is associated with a region of the surface;
(c) for each optical fiber, introducing unpolarized coherent light into the fiber to produce reference and measurement beams which optically interfere with each other, said reference beam comprising light that has been reflected by the cleaved end without passing out of the fiber and said measurement beam comprising light that has passed out of the fiber through the cleaved end, has reflected from the region of the surface associated with the fiber, and has reentered the fiber through the cleaved end; and
(d) for at least one of the optical fibers:
(i) splitting the interfering reference and measurement beams into two orthogonal components based on polarization;
(ii) individually detecting the intensities of said components; and
(iii) comparing said individually detected intensities to determine a property of the region of the surface associated with the fiber.

15. The method of claim 14 wherein for each optical fiber, less than 5 percent of the light that passes out of the fiber through the cleaved end in step (c) reflects from the region of the surface associated with the fiber.

16. The method of claim 14 wherein the property is selected from the group consisting of the presence of a defect with a high aspect ratio, the presence of a defect which comprises a change in the chemical composition of the surface, and combinations thereof.

17. The method of claim 16 wherein the defect with a high aspect ratio is a scratch, a bubble, or a combination thereof.

18. The method of claim 16 wherein the defect which comprises a change in the chemical composition of the surface is a stain, a platinum protrusion, a bubble, or a combination thereof.

19. The method of claim 14 wherein the sheet of material is a sheet of glass.

20. A method for inspecting a region of a surface of a sheet of material comprising:
(a) providing a polarization-maintaining optical fiber having a cleaved end;
(b) positioning the cleaved end adjacent to the region of the surface;
(c) introducing unpolarized coherent light into the fiber to produce reference and measurement beams which optically interfere with each other, said reference beam comprising light that has been reflected by the cleaved end without passing out of the fiber and said measurement beam comprising light that has passed out of the fiber through the cleaved end, has reflected from the region of the surface, and has reentered the fiber through the cleaved end;
(d) splitting the interfering reference and measurement beams into two orthogonal components based on polarization; and
(e) individually detecting the intensities of said components;
wherein the relative magnitudes of said individually detected intensities is indicative of a characteristic of the region of the surface which reflected the measurement beam.

21. The method of claim 20 wherein less than 5 percent of the light that passes out of the fiber through the cleaved end in step (c) reflects from the region of the surface.

22. The method of claim 20 wherein the characteristic is selected from the group consisting of the presence of a defect with a high aspect ratio, the presence of a defect which comprises a change in the chemical composition of the surface, and combinations thereof.

23. The method of claim 22 wherein the defect with a high aspect ratio is a scratch, a bubble, or a combination thereof.

24. The method of claim 22 wherein the defect which comprises a change in the chemical composition of the surface is a stain, a platinum protrusion, a bubble, or a combination thereof.

25. The method of claim 20 wherein the sheet of material is a sheet of glass.
